(19) United States
(12) Patent Application Publication
(10) Pub. No.: US 2026/0001212 A1
(43) Pub. Date: Jan. 1, 2026

(54) HANDS-FREE DYNAMIC TOOL & EQUIPMENT HOLDER

(71) Applicant: SMI Industries, LLC, Renton, WA (US)

(72) Inventors: Chris Lervick, Ketchikan, AK (US); Scott Thomas, Ketchikan, AK (US)

(73) Assignee: SMI Industries, LLC, Renton, WA (US)

(21) Appl. No.: 18/754,977

(22) Filed: Jun. 26, 2024

(51) Int. Cl. B25H 1/00

(52) U.S. Cl. CPC B25H 1/0021

(57) ABSTRACT

Provided herewith is a hands-free dynamic tool & equipment holder. Depicted is a portable holder apparatus for hands-free holding of tools and equipment, which apparatus may include a base stand, stabilizing legs, a holding sleeve, and a thumbscrew. The holding sleeve may be rotatably adjustable, with an adjustability section including angle adjustment teeth, functioning to facilitate angular rotation of the holding sleeve. Modular fastening mechanisms and accessory attachments may provide various functional features to the holder apparatus, and snap-together and three-piece assemblies may function to connect and define components of the holder apparatus.

### I. BACKGROUND

### A. Technical Field

The present disclosure pertains to the art of industrial tooling, welding, and assorted workspace management. Specifically, this disclosure teaches a hands-free equipment holder.

### B. Description of Related Art

Numerous mechanical and heavy industries require use of many different tools and equipment: Outdoor sports applications; removal of broken fasteners, frozen or rusted parts, broken or frozen engine or exhaust studs (heavy duty to smaller equipment applications); sweating pipe; brazing; cabin lanterns and camping (lighting and stoves); general illumination requirements including but not limited to adding hang mounts, applied to stove/lantern/elevated applications (lighting, flush mount, tree, wall, other surfaces aligned to its functionality, etc.).

Often, workers and operators within these industries must dynamically switch between tools, divert attention from one project to another, or between different workpieces, or otherwise find it preferable to have a holder within which to place tools and other devices. With so much varied activity taking place in often high-intensity, high-risk environments, proper workspace management also becomes of critical importance to ensure safety.

The National Fire Protection Association (NFPA) reported from 2014-2018, an annual average of 4,580 structure fires in industrial or manufacturing properties involved hot work, including welding and cutting, resulting in $484 million in direct property damage every year. [NFPA/08-23]. Workers using a propane torch may leave it on a non-level surface subsequently causing it to tip over and ignite nearby flammable materials. The resulting fire can cause millions of dollars in property damage, resident evacuation and displacement due to the signification building destruction. A less serious example of issues caused by inadequately secured tools involves a flashlight or other light source set on a nearby table to illuminate a workstation. If the light source is not properly held or secured while the operator is addressing other matters, the light source may fall and render the operator unable to see their work.

Mechanical stops, bases, and stands have been implemented in the past. These devices can hold various tools steady on a workspace surface, while an operator devotes attention to other, more pressing, issues. These devices, however, do not securely fasten to a surface and are otherwise prone to tipping or being knocked over by inattentive operators. This issue led to the introduction of bases and stands with features allowing attachment to a workspace surface.

However, despite addressing the securement issue, many of these improved devices lack ergonomic versatility. They are static, rotate only a limited number of degrees, or otherwise do not provide the full range of options for setup, angle, and secure attachment to different or variable surfaces.

There have been attempts in the past to address many of the above issues raised by those various technologies. For example, U.S. Pat. No. 11,149,943 describes a tool that holds a torch using magnets and a suction cup to secure it to a working surface. However, magnets are ineffective on nonferrous metals (e.g., stainless steel, aluminum, copper, brass), and suction cups do not adhere well to porous surfaces (e.g., wood, concrete, earth, gravel, sand). U.S. Pat. No. 3,144,232 describes a torch holder, but the device does not set the held tool's center of gravity at a precise point every time the gas cylinder is inserted into the canister, failing to effectively address the above stability issues, and similarly failing to increase the level of safety.

Industry workers need a hands-free tool holder that is secure, stable, and provides setup at all angles and on any workspace surface. Overall, the device disclosed herein attempts to provide those benefits and address all the above issues, while remaining user-friendly and increasing the level of safety for operators.

### II. Summary

In accordance with an aspect of the present invention, a holder apparatus including a base stand, at least two stabilizing legs disposed on a top surface of the base stand, a holding sleeve disposed between the at least two stabilizing legs, and a thumbscrew disposed on an outside surface of one of the at least two stabilizing legs. The holding sleeve may be rotatably adjustable relative to the base stand.

In accordance with another aspect of the present invention, a holder apparatus as above, wherein one of the at least two stabilizing legs may be a locking leg. The holder apparatus may also include an adjustability section disposed coincident with the locking leg, between the holding sleeve and the thumbscrew, which adjustability section includes angle adjustment teeth disposed on an outside surface of the holding sleeve and locking teeth disposed on an inside surface of the locking leg and corresponding to the angle adjustment teeth. The angle adjustment teeth and locking teeth may be engageable with each other, and the engagement between the adjustment teeth and the locking teeth may be capable of being selectively tightened or loosened. The thumbscrew may operatively engage the adjustability section to selectively tighten or loosen the engagement between the adjustment teeth and the locking teeth to facilitate angular rotation of the holding sleeve by a set number of degrees, and when the thumbscrew operatively engages the adjustability section to tighten the engagement between the adjustment teeth and the locking teeth, the orientation of the holding sleeve is fixed relative to the base stand.

In accordance with another aspect of the present invention, a holder apparatus as above, wherein the engagement between the adjustment teeth and the locking teeth increments the angular rotation by 8 degrees per tooth. The holder apparatus may further include a fastening mechanism disposed on the base stand, and the fastening mechanism may be at least one rare earth magnet, hanger clips, serrated teeth, bolts, stakes, rope eyelets, hoist rings, or locking clamps. The fastening mechanism may be selectively changeable. The stabilizing legs may be selectively length adjustable, and the holding sleeve may be selectively length adjustable. The holding sleeve and stabilizing legs may be made of polymer or composite resin. The holder apparatus may further include a vibration dampening and anti-slippage rubber cover disposed on the base stand and the rubber cover may be selectively removable. The holder apparatus may further include a serrated cover disposed on the base stand, and the serrated cover may be selectively removable. The holding sleeve may be cylindrical, and the holder apparatus may further include a compression ring disposed around the holding sleeve. The compression ring can accommodate cylinders of variable diameter.

In accordance with another aspect of the present invention, a holder apparatus as above, including a base stand having a top surface and a bottom surface, wherein the base stand and the stabilizing legs have a snap-together assembly. The snap-together assembly may include snap extrusions disposed on each of the at least two stabilizing legs and snap depressions in the top surface of the base stand, a number of which corresponding to the number of stabilizing leg snap extrusions. The snap extrusions may operatively engage the base stand snap depressions, and when the snap extrusions operatively engage the base stand snap depressions, the at least two stabilizing legs may be affixed to the base stand. The base stand may have a center cutout. The holding sleeve may have a three-piece assembly including a locking half, a support half, and a locking sleeve, configured to enclose a bottom section of the holding sleeve, around both the locking half and support half. The locking half and the support half may be configured to fit together to define the holding sleeve, wherein the holding sleeve has a cutout.

In accordance with another aspect of the present invention, a holder apparatus as above, including a cover sleeve selectively attachable to the holding sleeve and configured to cover and protect objects placed within the holder apparatus. The holder apparatus may further include an accessory attachment, and the accessory attachment may be a magnification device selectively attachable to the at least two stabilizing legs, a lighting fixture selectively attachable to the at least two stabilizing legs, or a soldering iron selectively attachable to the base stand.

In accordance with another aspect of the present invention, a holder apparatus including a base stand having a top surface and a bottom surface, at least two stabilizing legs disposed on the top surface of the base stand, a holding sleeve disposed between the at least two stabilizing legs, and a thumbscrew disposed on an outside surface of one of the at least two stabilizing legs. The holding sleeve may be rotatably adjustable relative to the base stand, and one of the at least two stabilizing legs may be a locking leg. The holder apparatus may also include an adjustability section disposed coincident with the locking leg, between the holding sleeve and the thumbscrew, which adjustability section includes angle adjustment teeth disposed on an outside surface of the holding sleeve and locking teeth disposed on an inside surface of the locking leg and corresponding to the angle adjustment teeth. The angle adjustment teeth and locking teeth may be engageable with each other, and the engagement between the adjustment teeth and the locking teeth may be capable of being selectively tightened or loosened. The thumbscrew may operatively engage the adjustability section to selectively tighten or loosen the engagement between the adjustment teeth and the locking teeth to facilitate angular rotation of the holding sleeve by a set number of degrees, and when the thumbscrew operatively engages the adjustability section to tighten the engagement between the adjustment teeth and the locking teeth, the orientation of the holding sleeve is fixed relative to the base stand. The engagement between the adjustment teeth and the locking teeth increments the angular rotation by 8 degrees per tooth. The base stand and the stabilizing legs may have a snap-together assembly. The snap-together assembly may include snap extrusions disposed on each of the at least two stabilizing legs and snap depressions in the top surface of the base stand, a number of which corresponding to the number of stabilizing leg snap extrusions. The snap extrusions may operatively engage the base stand snap depressions, and when the snap extrusions operatively engage the base stand snap depressions, the at least two stabilizing legs may be affixed to the base stand. The base stand may have a center cutout. The holding sleeve may have a three-piece assembly including a locking half, a support half, and a locking sleeve, configured to enclose a bottom section of the holding sleeve, around both the locking half and support half. The locking half and the support half may be configured to fit together to define the holding sleeve, wherein the holding sleeve has a cutout. The holding sleeve may be cylindrical, and the holder apparatus may include a compression ring disposed around the holding sleeve, wherein the compression ring can accommodate cylinders of variable diameter.

Other benefits and advantages of this invention will become apparent to those skilled in the art to which it pertains upon reading and understanding of the following detailed specification.

### III. BRIEF DESCRIPTION OF THE FIGURES

The above drawings form part of the disclosure and specification and are included to further demonstrate certain aspects of the invention, which aspects will be described in detail later in this specification. The invention may be better understood by reference to these drawings in conjunction with the detailed description.

FIG. 1 is a perspective view of a particular embodiment of the invention

FIG. 2 is a side view of the particular embodiment of the invention seen in FIG. 1, with a cutaway of the thumb screw.

FIG. 3 is a front view of the particular embodiment of the invention seen in FIG. 1.

FIG. 4 is a bottom view of the particular embodiment of the invention seen in FIG. 1.

FIG. 5 is a perspective view of the particular embodiment of the invented sleeve.

FIG. 6 is a top view of the particular embodiment of the sleeve seen in FIG. 5.

FIG. 7 is a side view of the particular embodiment of the sleeve seen in FIG. 5.

FIG. 8 is a rear view of the particular embodiment of the sleeve seen in FIG. 5.

FIG. 9 is a side view of the particular embodiment of the sleeve seen in FIG. 5 with the side cutaway.

FIG. 10 is a rear view of the particular embodiment of the sleeve seen in FIG. 5 with a cutaway of the locking sleeve.

FIG. 11 is a perspective view of a particular embodiment of the base and leg assembly

FIG. 12 is a top view of the particular embodiment of the assembly seen in FIG. 11.

FIG. 13 is a side view of the particular embodiment of the assembly seen in FIG. 11.

FIG. 14 is a bottom view of the particular embodiment of the assembly seen in FIG. 11.

FIG. 15 is a perspective view of a particular embodiment of the invention.

FIG. 16 is a side view of the particular embodiment of the invention seen in FIG. 15.

FIG. 17 is a front view of the particular embodiment of the invention seen in FIG. 15.

FIG. 18 is a bottom view of the particular embodiment of the invention seen in FIG. 15.

FIG. 19 is a perspective view of the particular embodiment of the invented sleeve.

FIG. 20 is a top view of the particular embodiment of the invented sleeve in FIG. 19.

FIG. 21 is a side view of the particular embodiment of the invented sleeve in FIG. 20.

FIG. 22 is a rear view of the particular embodiment of the invented sleeve in FIG. 20.

FIG. 23 is a perspective view of a particular embodiment of the invention.

FIG. 24 is a perspective view of the particular embodiment of the invention seen in FIG. 23 with a cutaway of the thumb screw.

FIG. 25 is a front view of the particular embodiment of the invention seen in FIG. 23.

FIG. 26 is a bottom view of the particular embodiment of the invention seen in FIG. 23.

FIG. 27 is a perspective view of the particular embodiment of the invented sleeve.

FIG. 28 is a top view of the particular embodiment of the sleeve seen in FIG. 28.

FIG. 29 is a side view of the particular embodiment of the sleeve seen in FIG. 28.

FIG. 30 is a rear view of the particular embodiment of the sleeve seen in FIG. 28.

FIG. 31 is a front view of a particular embodiment of the stabilizing and locking legs, showing the locking teeth.

### IV. DETAILED DESCRIPTION

The device herein described may function as a portable gimbal (stabilizing device; usually fastened/used to illuminate or heat) with up to 360 degrees tilt & swivel whether free standing, mounted, hung, or locked and secured in place at a desired angle. It may be a portable stand for tools and canisters filled with accelerants including but not limited to TIG inert gas, electric TIG torch, Nitrous Oxide, Oxygen, Propane, compressed gas, nonferrous and ferrous metals (etc.) When used with such cannisters, the sleeve section can be adapted to almost any size within reason, and there is no limit on the contents of the canisters that can be used. The canister can hold any type of compressed gas. The holder apparatus may embody an adjustable variable degree stand for tools filled with accelerants, and other compressed gasses and torches and may be made of plastic polymers and/or composite resins. It may precisely hold tools and equipment in place at any angle (360°) whether suspended, mounted, hung, or locked in place, with detents that support precise locking positions throughout the 360 degree locking positions. It features a stabilization base stand for portable, hand-held torches, cylindrical torch stability and safety, and safety stand for active flame tools. The holder apparatus may feature a compact, multi-part design, a torch extension stand, and low center of gravity enhancing anti-tip stability. The holder apparatus may be hands-free and accommodate various containers and vessels of various shapes and sizes. It may be configured to be corrosion resistant and have an engineered balance to 360°-degree tilt with precision control. The holder apparatus can securely house a multitude of vessels, of various shapes and sizes requiring a secure platform with the versatility of rotating at precise angles in both consumer and industrial applications. The holder apparatus can be configured to easily accept replacement or modular parts. The holder apparatus may be mobile, capable of being brought to the item being worked on, as opposed to other devices that require the work to be brought to them and can be placed on a variety of surfaces, including nonferrous metals and porous materials. This feature is particularly useful when camping outdoors, where surfaces are often uneven. The holder apparatus can hold and level various attachments commonly used with gas cylinders, such as camping stoves and lanterns, and can be leveled on various surfaces, including roofs, beaches, and outdoor camping areas. The holder apparatus can ensure accurate and consistent positioning of the center of gravity by incorporating two features: a specific depth and an internal compression ring, to securely hold the tool or equipment in the same position, maintaining a stable center of gravity and preventing the possibility of tipping over. The holder apparatus may include a hanger that fastens to a wall for storage and, after use, may be locked in an upright vertical position for safe and secure storage when not in use.

Reference is now made to the drawings wherein the showings are for purposes of illustrating embodiments of the article only and not for purposes of limiting the same, and wherein like reference numerals are understood to refer to like components.

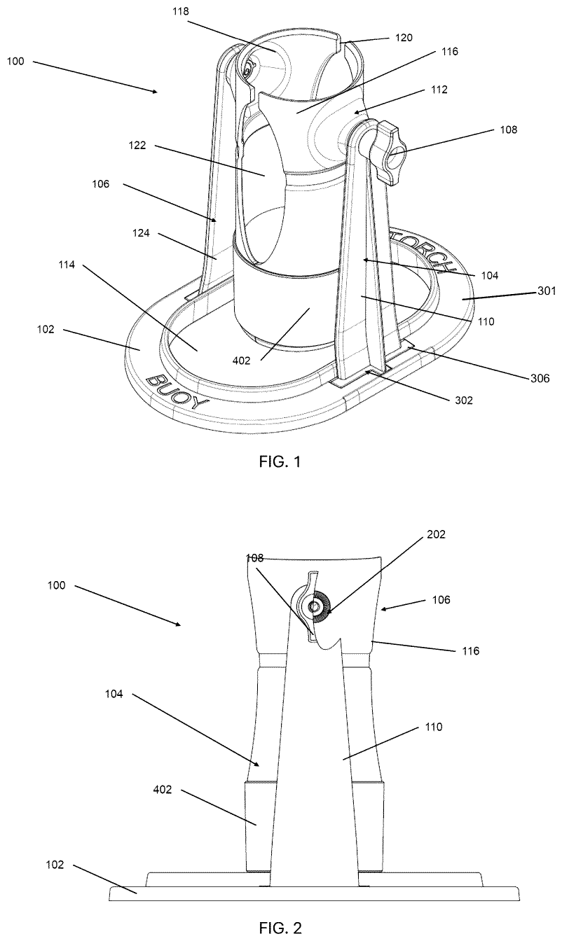

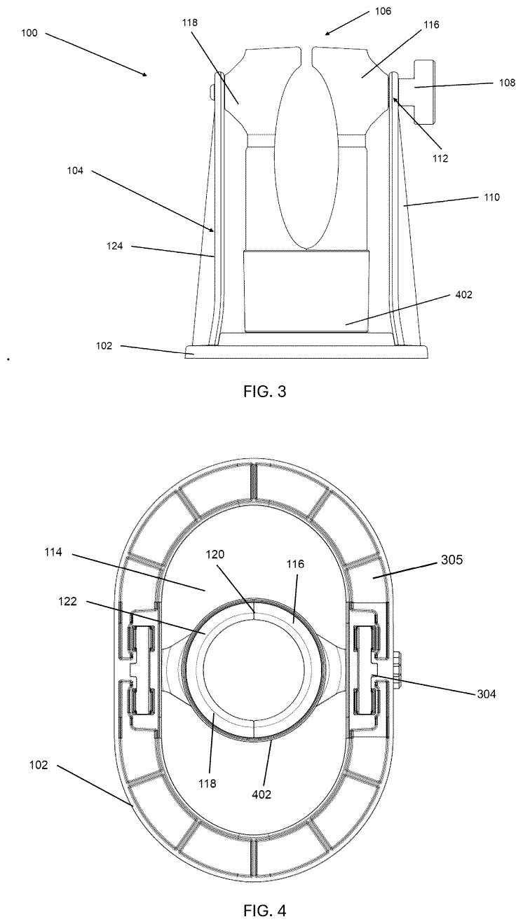

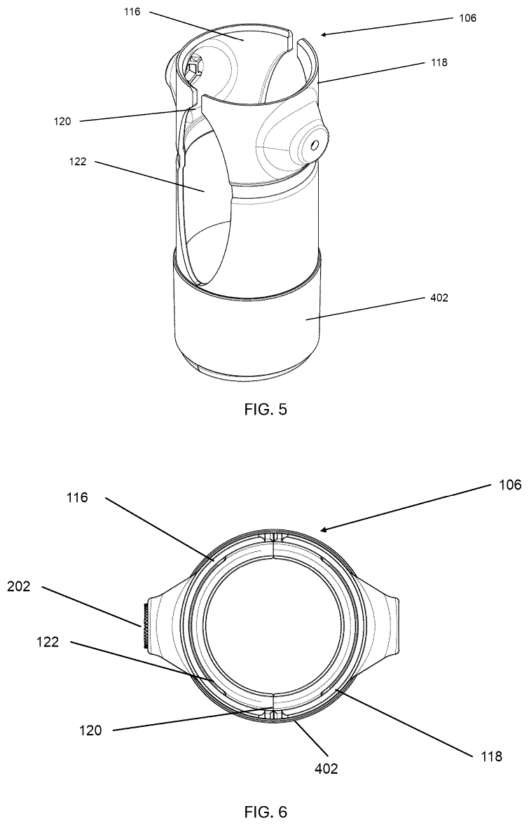

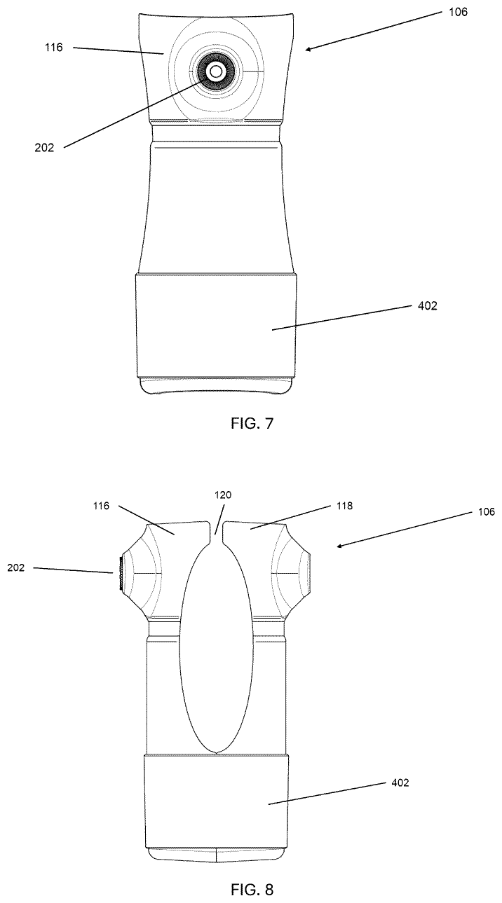

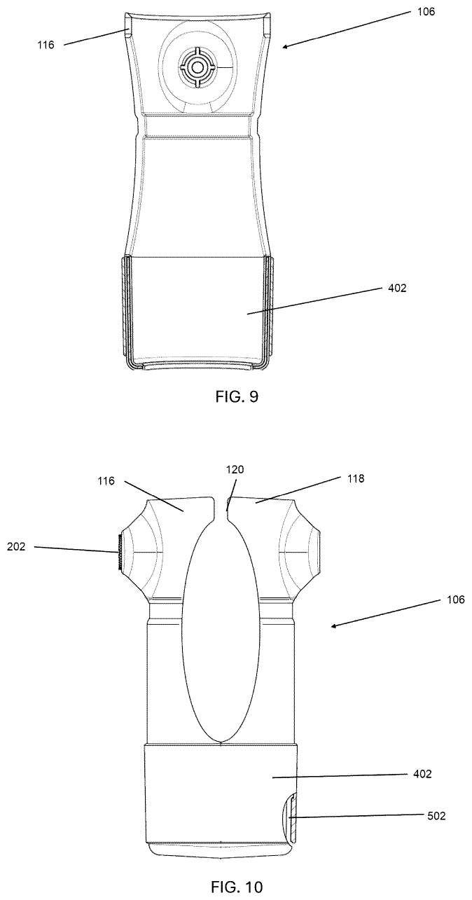

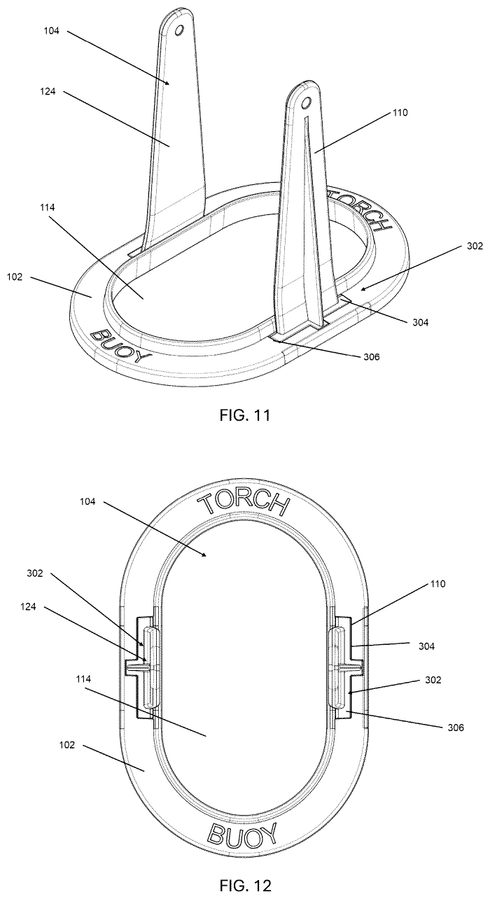

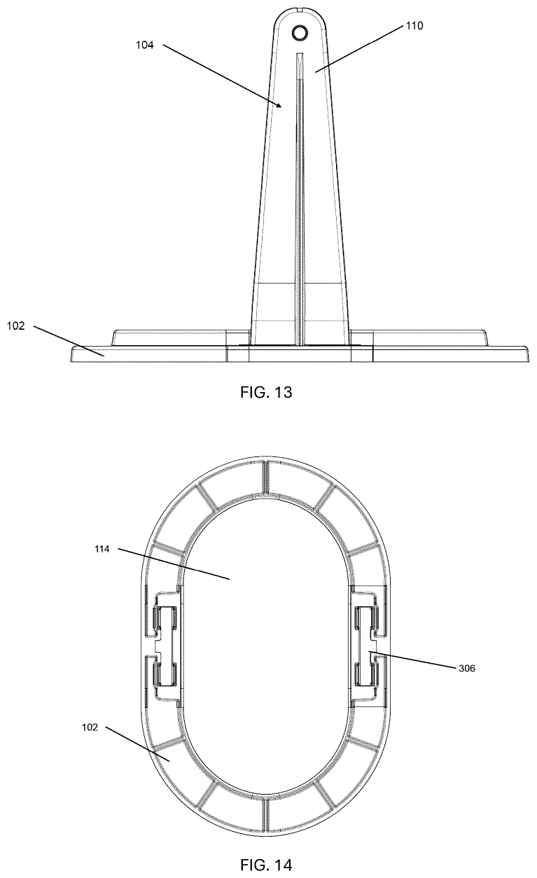

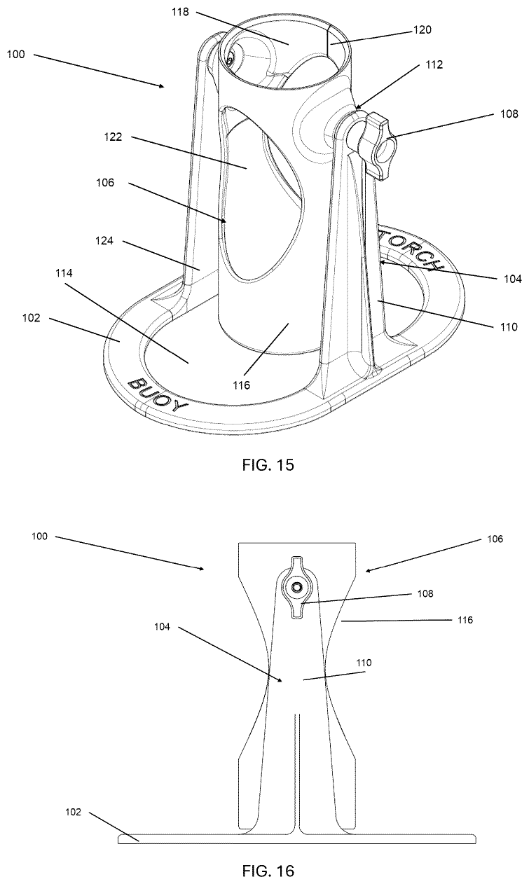

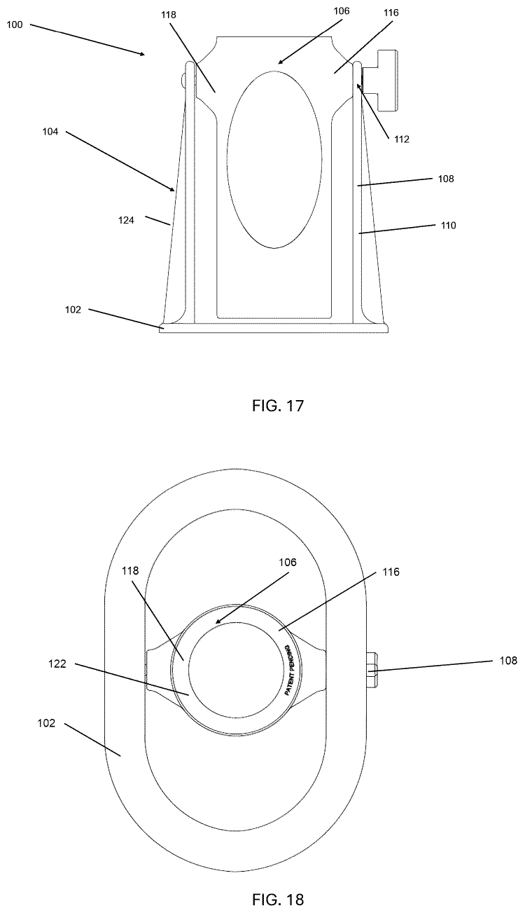

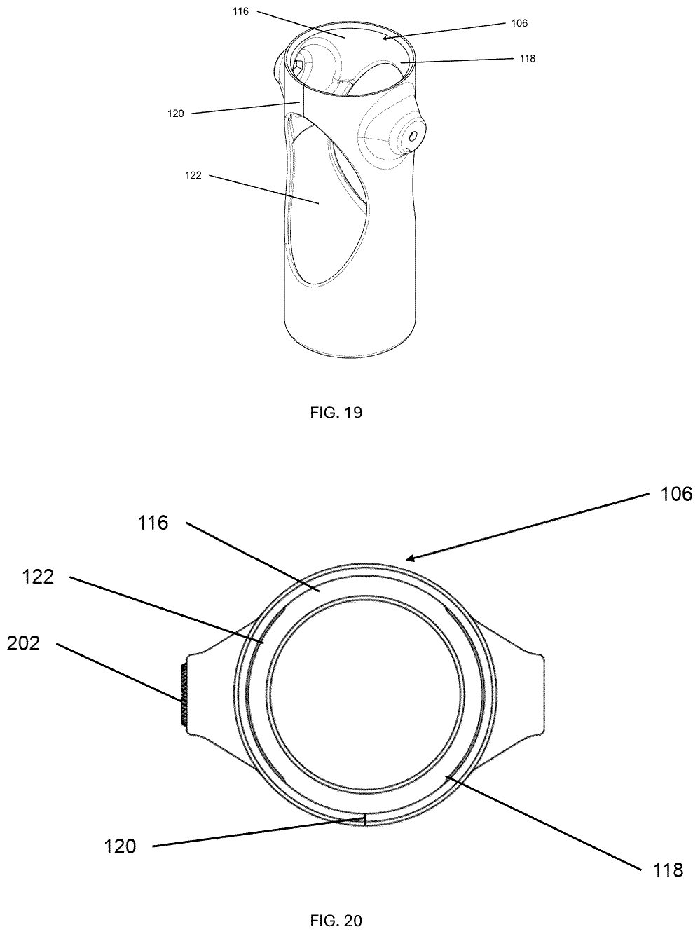

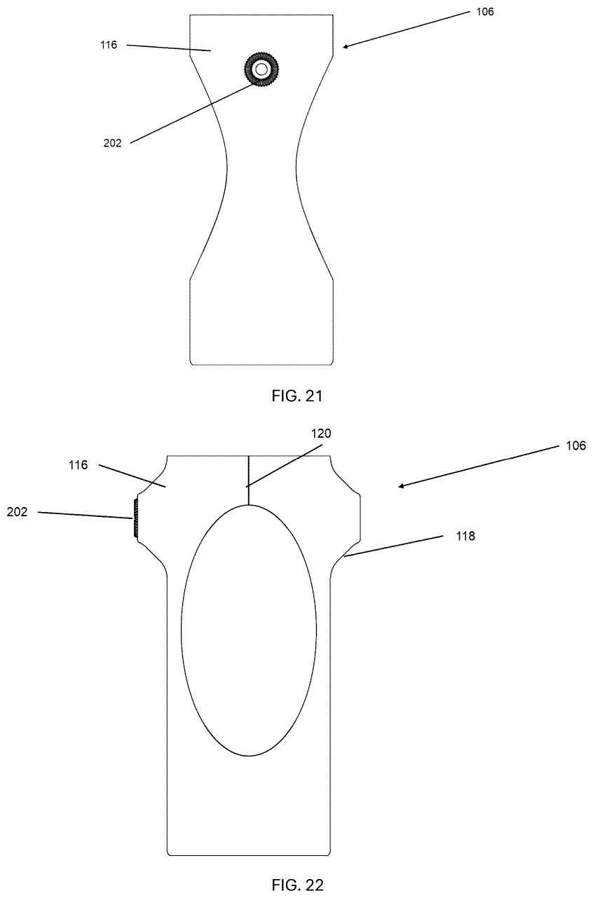

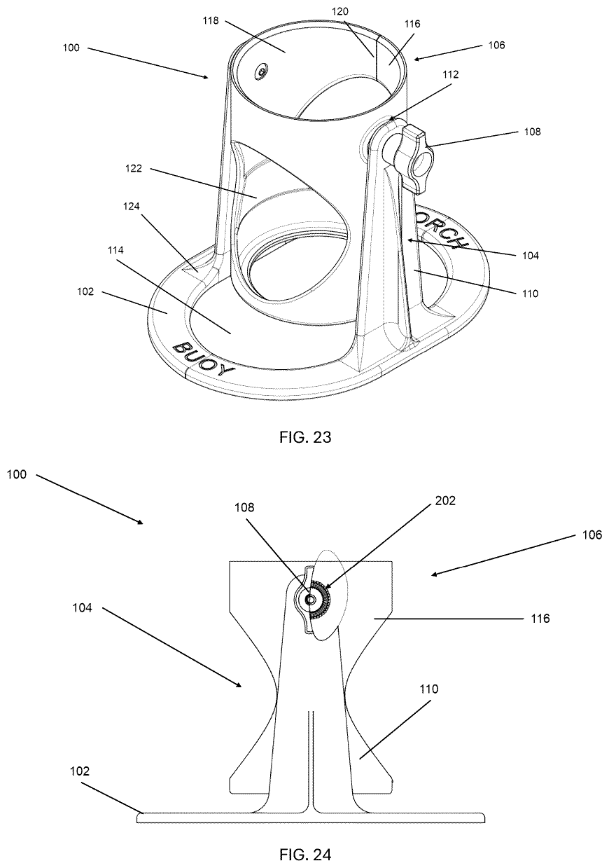

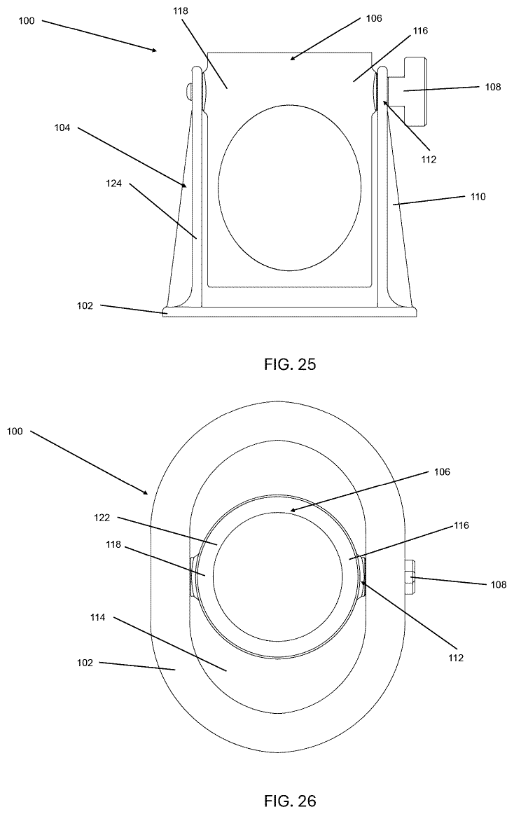

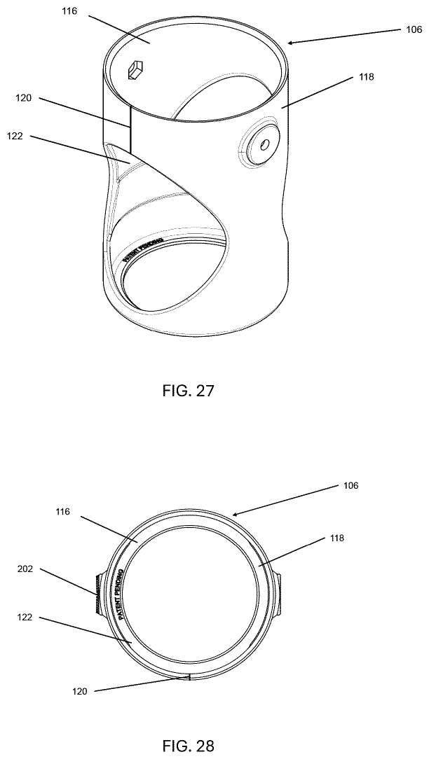

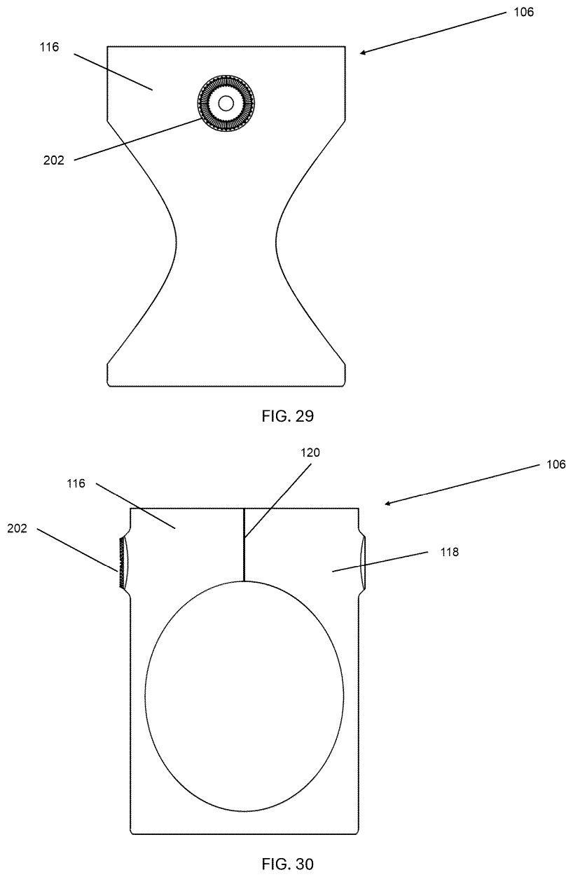

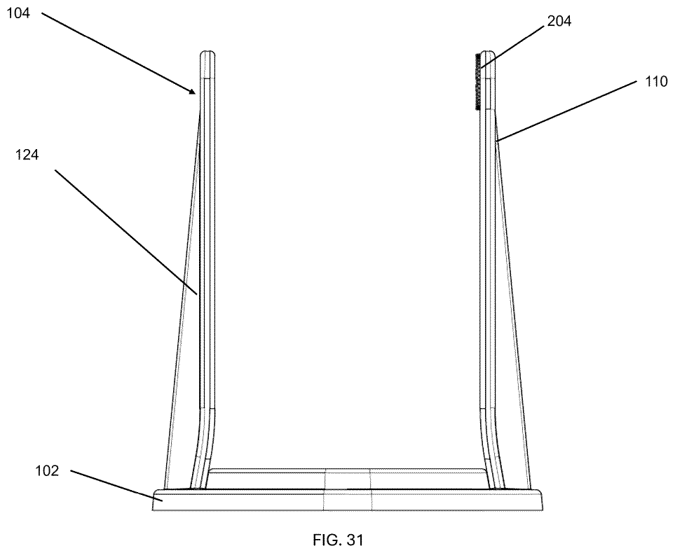

FIGS. 1-31 depict a holder apparatus 100 for hands-free holding of tools and equipment. The holder apparatus 100 may include a base stand 102, stabilizing legs 104 disposed on a top surface of the base stand 102, a holding sleeve 106 disposed between the stabilizing legs 104, and a thumbscrew 108 disposed on an outside surface of one of the stabilizing legs 104. The present embodiment shows a cylindrical holding sleeve 106, but alternative shapes and sizes are contemplated to conform to different tool shapes and sizes, including but not limited to square, ovular, or rectangular shapes. The invention similarly contemplates varying holding sleeve 106 and stabilizing leg 104 lengths. The holding sleeve 106 and stabilizing legs 104 may be selectively length adjustable, and the base stand 102, holding sleeve 106, and stabilizing legs 104 may be made of polymer or composite resin, as nonlimiting examples of material composition. The base stand 102 and holding sleeve 106 may be interchangeable to different shapes, sizes and configurations of base stands and holding sleeves for different purposes. The holding sleeve 106 and stabilizing legs 104 may be telescoping or possess telescoping features to facilitate selective length adjustability. The holder apparatus may have adjustable leveling feet. The holding sleeve 106 may be rotatably adjustable relative to the base stand 102, as described in detail further below.

With particular reference to FIGS. 1 & 2, one of the stabilizing legs 104 may be a locking leg 110, with the remaining legs being supporting legs 124. The holder apparatus 100 may also include an adjustability section 112 disposed coincident with the locking leg 110, between the holding sleeve 106 and the thumbscrew 108. The adjustability section 112 may include angle adjustment teeth 202 disposed on an outside surface of the holding sleeve 106 and locking teeth 204 disposed on an inside surface of the locking leg 110 and corresponding to the angle adjustment teeth 202 In a particular embodiment, the locking leg may have up to 42 locking teeth 204 disposed on its inside surface, and 42 angle adjustment teeth 202. locking teeth 204 and angle adjustment teeth 202 may mesh at the adjustability section 112, at a pivot point on the holder 100. The interaction between the holding sleeve 106, thumbscrew 108, and adjustability section 112 on the locking leg 110 may function to facilitate angular rotation of the holding sleeve, as described further below.

The holder apparatus 100 may further include a fastening mechanism, which may be selectively changeable, disposed on the base stand 102. Examples of contemplated fastening mechanisms include, but are not limited to one or more rare earth magnets, hangers, hanger clips, serrated teeth, bolts, stakes, rope eyelets, hoist rings, or locking clamps. The holder apparatus 100 may further include a selectively removable cover disposed on the base stand 102. The cover may be a vibration dampening and anti-slippage rubber cover or a serrated cover, as nonlimiting examples. For example, by incorporating an anti-slippage rubber cover, which may securely fit over the base stand 102, the coefficient of friction may be significantly increased, making the holder apparatus 100 highly effective on surfaces like roofing material. In a particular embodiment, the holder apparatus 100 may further include a compression ring 122 disposed around the holding sleeve 106. The compression ring 122 may work to secure the tool or equipment within the holding sleeve 106 and may use a push-and-clip mechanism, as a quick release design. The compression ring 122 may secure the tool or equipment in such a way that the tool or equipment may rotate in place. In many embodiments, the compression ring 122 may be integrated into the holding sleeve 106. The compression ring 122 may accommodate cylinders of variable diameter.

The holder apparatus 100 may further include a cover sleeve selectively attachable to the holding sleeve 106 and configured to cover and protect tools and equipment placed within the holder apparatus 100. The holder apparatus 100 may similarly include a valve assembly (the portion of a compressed cylinder that is most likely to combust or cause gas leaks) protective sleeve. In a particular embodiment, the holder apparatus 100 may further include an accessory attachment. Examples of contemplated accessory attachments include, but are not limited to a magnification device selectively attachable to the stabilizing legs 104, a lighting fixture selectively attachable to the stabilizing legs 104, or a soldering iron selectively attachable to the base stand 102. The accessory attachments may be modular, capable of quick attachment and removal using clips or snaps, as nonlimiting examples of attachment and removal mechanisms.

With particular reference to FIGS. 1-14, according to a particular embodiment, the holder apparatus base stand 102 and the stabilizing legs 104 may have a snap-together assembly 302, and the holding sleeve 106 may have a three-piece assembly 303. The base stand 102 may have a defined top surface 301 and bottom surface 305. The snap-together assembly 302 may include snap extrusions 304 disposed on each of the stabilizing legs 104 and snap depressions 306 in the top surface 301 of the base stand 102, a number of which corresponding to the number of stabilizing leg snap extrusions 302. The base stand 102 may have a center cutout 114.

With continued reference to FIGS. 1-14, the holding sleeve three-piece assembly 303 may include a locking half 116, a support half 118, and a locking sleeve 402 configured to enclose a bottom section of the holding sleeve 106, around both the locking half 116 and support half 116. The snap-together assembly 302 and three-piece assembly 303 may function to connect and define components of the holder apparatus, as discussed further below.

With reference to FIGS. 1 & 2, and in a particular embodiment, the holder apparatus 100 features may interact to allow the holding sleeve 106 to rotatably adjust relative to the base stand 102. The holding sleeve 106 is supported and lifted by the stabilizing 104 and locking 110 legs. The angle adjustment teeth 202 and locking teeth 204 engage with each other. The thumbscrew 108 on one side of the pivot point, on the locking leg 110 tightens and loosens the opposing sides of the holder apparatus 100 holding sleeve 106 and stabilizing legs 104, tightening or loosening the engagement between the angle adjustment teeth 202 and the locking teeth 204. After loosening the engagement, a user physically turns the holding sleeve 106, whereby the adjustment teeth 202 and the locking teeth 204 slide past each other incrementally, one tooth at a time. After achieving the desired level position and orientation angle, the user turns the thumbscrew 108 to tighten the engagement between the angle adjustment teeth 202 and the locking teeth 204 to secure the holding sleeve 106 and lock the angle relative to the base stand 102. In this manner, the level of engagement between the angle adjustment teeth 202 and the locking teeth 204 may facilitate fine angular adjustment when the thumbscrew 108 is loosened and lock together securely when the thumbscrew 108 tightened, after achieving the desired level position and orientation angle. The adjustment component of the holder apparatus 100 provides the locking force when tightened in the desired position, making it much safer. The angular rotation of the holding sleeve 106 may be varied by a set number of degrees. In a particular, nonlimiting, embodiment the angular rotation may be adjusted in increments of amounts between 5 degrees and 10 degrees. In another particular embodiment the engagement between the adjustment teeth 202 and the locking teeth 204 increments the angular rotation by 8 degrees per tooth.

The holder 100 may maintain a low center of gravity by holding the tool or equipment—which may be a gas cannister—as close as possible to the base stand 102 and the surface that the holder 100 is resting upon. The tool or equipment may be inserted until it seats fully within the holding sleeve 106. In a particular embodiment, the bottom of the holding sleeve may be ¼ inches away from the surface that the holder 100 is resting upon when in an upright (tangent to gravity) position. The pivot point of the holder 100 may be located at the center of mass of the tool or equipment when holding the tool or equipment and any conceivable attachment. These factors contribute to maintaining a “low center of gravity.”

With particular reference to FIGS. 1-14, and in a particular embodiment, the snap-together assembly 302 and three-piece assembly 303 may function to connect and define components of the holder apparatus. A user may take each of the base stand 102, stabilizing legs 104, locking half 116, support half 118, and locking sleeve 402 and snap them together to construct the complete holder apparatus 100. The stabilizing legs 102 are snapped into the base stand 102, via the snap extrusions 304, which may operatively engage the base stand snap depressions 306, affixing the stabilizing legs 104 to the base stand 102. The locking half 116 and support half 118 of the holding sleeve 106 can be snapped together, and the locking sleeve 402 slideably covering a section of the affixed locking half 116 and support half 118 to secure the two halves together. In this manner, the snap extrusions 304 operatively engage the base stand snap depressions 306 to affix the stabilizing legs 104 to the base stand 102, and the locking half 116, support half 118, and locking sleeve 402 may be fit together to define the holding sleeve 106, which holding sleeve 106 may or may not have a cutout.

Numerous aspects have been described, hereinabove. While the holder apparatus provided herein has been described in connection with various illustrative embodiments, it is to be understood that other similar embodiments may be used or modifications and additions may be made to the described embodiments for performing the same function disclosed herein without deviating therefrom. Further, all embodiments disclosed are not necessarily in the alternative, as various embodiments may be combined to provide the desired characteristics. It will be apparent to those skilled in the art that the above methods and apparatuses may incorporate changes and modifications without departing from the spirit and scope of the present disclosure. It is intended to include all such modifications and alterations in so far as they come within the scope of the appended claims or the equivalents thereof. Therefore, the holder apparatus should not be limited to any single embodiment, but rather construed in breadth and scope in accordance with the recitations of the appended claims.

What is claimed:

1. A holder apparatus comprising:
a base stand;
at least two stabilizing legs disposed on a top surface of the base stand;
a holding sleeve disposed between the at least two stabilizing legs;
a thumbscrew disposed on an outside surface of one of the at least two stabilizing legs; and
wherein the holding sleeve is rotatably adjustable relative to the base stand.

2. A holder apparatus as in claim 1, further comprising:
wherein one of the at least two stabilizing legs is a locking leg;
an adjustability section disposed coincident with the locking leg, between the holding sleeve and the thumbscrew, the adjustability section comprising:
angle adjustment teeth disposed on an outside surface of the holding sleeve;
locking teeth disposed on an inside surface of the locking leg and corresponding to the angle adjustment teeth;
wherein the angle adjustment teeth and locking teeth are engageable with each other;
wherein the engagement between the adjustment teeth and the locking teeth is capable of being selectively tightened or loosened;
wherein the thumbscrew operatively engages the adjustability section to selectively tighten or loosen the engagement between the adjustment teeth and the locking teeth to facilitate angular rotation of the holding sleeve by a set number of degrees; and
wherein, when the thumbscrew operatively engages the adjustability section to tighten the engagement between the adjustment teeth and the locking teeth, the orientation of the holding sleeve is fixed relative to the base stand.

3. A holder apparatus as in claim 2 wherein the engagement between the adjustment teeth and the locking teeth increments the angular rotation by 8 degrees per tooth.

4. A holder apparatus as in claim 1 further comprising a fastening mechanism disposed on the base stand.

5. A holder apparatus as in claim 4, wherein the fastening mechanism is selected from the group comprising (i) at least one rare earth magnet, (ii) hanger clips, (iii) serrated teeth, (iv) bolts, (v) stakes, (vi) rope eyelets, (vii) hoist rings, and (viii) locking clamps.

6. A holder apparatus as in claim 5, wherein the fastening mechanism is selectively changeable.

7. A holder apparatus as in claim 1, wherein the stabilizing legs are selectively length adjustable.

8. A holder apparatus as in claim 1, wherein the holding sleeve is selectively length adjustable.

9. A holder apparatus as in claim 1 wherein the holding sleeve and stabilizing legs are made of a material selected from the group comprising (i) polymer, and (ii) composite resin.

10. A holder apparatus as in claim 1 further comprising:
a vibration dampening and anti-slippage rubber cover disposed on the base stand; and
wherein the rubber cover is selectively removable.

11. A holder apparatus as in claim 1 further comprising:
a serrated cover disposed on the base stand; and
wherein the serrated cover is selectively removable.

12. A holder apparatus as in claim 1 further comprising:
wherein the holding sleeve is cylindrical;
a compression ring disposed around the holding sleeve; and
wherein the compression ring accommodates cylinders of variable diameter.

13. A holder apparatus as in claim 1 further comprising:
a base stand having a top surface and a bottom surface;
wherein the base stand and the stabilizing legs have a snap-together assembly comprising:
snap extrusions disposed on each of the at least two stabilizing legs;
snap depressions in the top surface of the base stand, a number of which corresponding to the number of stabilizing leg snap extrusions;
wherein the snap extrusions operatively engage the base stand snap depressions;
wherein when the snap extrusions operatively engage the base stand snap depressions, the at least two stabilizing legs are affixed to the base stand;
wherein the base stand has a center cutout;
wherein the holding sleeve has a three-piece assembly comprising:
a locking half;
a support half;
wherein the locking half and the support half are configured to fit together to define the holding sleeve;
a locking sleeve, configured to enclose a bottom section of the holding sleeve, around both the locking half and support half;
wherein the holding sleeve has a cutout.

14. A holder apparatus as in claim 1 further comprising a cover sleeve selectively attachable to the holding sleeve and configured to cover and protect objects placed within the holder apparatus.

15. A holder apparatus as in claim 1 further comprising an accessory attachment.

16. A holder apparatus as in claim 15, wherein the accessory attachment is selected from the group comprising:
(i) a magnification device selectively attachable to the at least two stabilizing legs;
(ii) a lighting fixture selectively attachable to the at least two stabilizing legs; and
(iii) a soldering iron selectively attachable to the base stand.

17. A holder apparatus comprising:
a base stand having a top surface and a bottom surface;
at least two stabilizing legs disposed on the top surface of the base stand;
a holding sleeve disposed between the at least two stabilizing legs;
a thumbscrew disposed on an outside surface of one of the at least two stabilizing legs;
wherein the holding sleeve is rotatably adjustable relative to the base stand;
wherein one of the at least two stabilizing legs is a locking leg;
an adjustability section disposed coincident with the locking leg, between the holding sleeve and the thumbscrew, the adjustability section comprising:
angle adjustment teeth disposed on an outside surface of the holding sleeve;
locking teeth disposed on an inside surface of the locking leg and corresponding to the angle adjustment teeth;
wherein the angle adjustment teeth and locking teeth are engageable with each other;
wherein the engagement between the adjustment teeth and the locking teeth is capable of being selectively tightened or loosened;
wherein the thumbscrew operatively engages the adjustability section to selectively tighten or loosen the engagement between the adjustment teeth and the locking teeth to facilitate angular rotation of the holding sleeve by a set number of degrees;
wherein, when the thumbscrew operatively engages the adjustability section to tighten the engagement between the adjustment teeth and the locking teeth, the orientation of the holding sleeve is fixed relative to the base stand;
wherein the engagement between the adjustment teeth and the locking teeth increments the angular rotation by 8 degrees per tooth;
wherein the base stand and the stabilizing legs have a snap-together assembly comprising:
snap extrusions disposed on each of the at least two stabilizing legs;
snap depressions in the top surface of the base stand, a number of which corresponding to the number of stabilizing leg snap extrusions;
wherein the snap extrusions operatively engage the base stand snap depressions;
wherein when the snap extrusions operatively engage the base stand snap depressions, the at least two stabilizing legs are affixed to the base stand;
wherein the base stand has a center cutout;
wherein the holding sleeve has a three-piece assembly comprising:
a locking half;
a support half;
wherein the locking half and the support half are configured to fit together to define the holding sleeve;
a locking sleeve, configured to enclose a bottom section of the holding sleeve, around both the locking half and support half;
wherein the holding sleeve has a cutout;
wherein the holding sleeve is cylindrical;
a compression ring disposed around the holding sleeve; and
wherein the compression ring accommodates cylinders of variable diameter.
